(19) United States
(12) Patent Application Publication
(10) Pub. No.: US 2022/0311519 A1
(43) Pub. Date: Sep. 29, 2022

(54) TRANSMITTER, RECEIVER, AND COMMUNICATION SYSTEM

(71) Applicant: FUJIKURA LTD., Tokyo (JP)

(72) Inventor: Yoshinori Arai, Chiba (JP)

(73) Assignee: FUJIKURA LTD., Tokyo (JP)

(21) Appl. No.: 17/635,532

(22) PCT Filed: Aug. 31, 2020
(86) PCT No.: PCT/JP2020/032940

§ 371 Date: Feb. 15, 2022

(30) Foreign Application Priority Data
Aug. 29, 2019 (JP) 2019-157440

(51) Int. Cl. H04B 10/50; H04B 10/69

(52) U.S. Cl. CPC H04B 10/50; H04B 10/69

(57) ABSTRACT

A transmitter includes: a substrate; a signal source disposed on the substrate; an electrical-to-optical (E/O) converter disposed on the substrate and that converts an electrical signal outputted from the signal source into an optical signal; an optical cable that carries the optical signal; and an optical connector disposed at an end of the optical cable. The electrical signal is inputted into the E/O converter.

### TECHNICAL FIELD

The present invention relates to a transmitter for transmitting an optical signal, a receiver for receiving the optical signal, and a communication system for transmitting and receiving the optical signal.

### BACKGROUND

Inter-device communications have conventionally been conducted by using a metal cable as a transmission medium to transmit and receive electrical signals. A universal serial bus (USB) cable and a high-definition digital media interface (HDMI) (registered trademark) cable are typical examples of the metal cable that is used in the inter-device communications.

However, it is difficult to increase a transmission distance and a transmission rate in the inter-device communications using a metal cable. As a solution to this problem, an active optical cable (AOC) has recently been receiving attention as a transmission medium which replaces the metal cable. The AOC is composed of (1) an optical cable, (2) a first connector which is provided at one end of the optical cable and which incorporates an electrical-to-optical (E/O) converter, and (3) a second connector which is provided at the other end of the optical cable and which incorporates an optical-to-electrical (OLE) converter. An electrical signal outputted from a transmitting-side device (for example, a camera) is converted, by the E/O converter of the first connector that is connected to the transmitting-side device, into an optical signal, which is then transmitted through the optical cable. The optical signal having been transmitted through the optical cable is converted, by the OLE converter of the second connector that is connected to a receiving-side device (for example, a grabber), into an electrical signal, which is then inputted to the receiving-side device. The AOC is disclosed in, for example, Patent Literature 1.

### PATENT LITERATURE

Patent Literature 1
Japanese Patent Application Publication Tokukai No. 2012-60522

In the inter-device communications using an AOC, electrical signals such as USB signals and HDMI signals, which are compliant with general-purpose communications standards, are converted into optical signals. Therefore, the transmitting-side device needs to include a communications interface for converting an original signal (an electrical signal outputted by a signal source) into an electrical signal that is compliant with a general-purpose communications standard. In addition, the receiving-side device needs to include a communications interface for extracting the original signal from the electrical signal that is compliant with the general-purpose communications standard. This makes it difficult to make more compact or simpler both the transmitting-side device and the receiving-side device.

One or more embodiments of the invention provide a transmitter that is easy to make more compact or simpler, provide a receiver that is easy to make more compact or simpler, or provide a communication system in which a transmitter and a receiver are easy to make more compact or simpler.

### SUMMARY

A transmitter in accordance with one or more embodiments of the present invention includes a configuration in which the transmitter includes: a substrate; a signal source provided to the substrate; an E/O converter provided to the substrate and configured to convert, into an optical signal, an electrical signal outputted from the signal source; an optical cable that carries the optical signal outputted from the E/O converter; and an optical connector provided at an end of the optical cable, the electrical signal outputted from the signal source being inputted as is into the E/O converter.

A receiver in accordance with one or more embodiments of the present invention includes: a configuration in which the receiver includes an OLE converter configured to convert an optical signal into an electrical signal; and a receiver circuit configured to process, as an electrical signal outputted from a signal source, the electrical signal outputted from the OLE converter.

A communication system in accordance with one or more embodiments of the present invention includes a configuration in which the communication system includes a transmitter in accordance with one or more embodiments of the present invention; and a receiver in accordance with one or more embodiments of the present invention.

One or more embodiments of the present invention make it possible to provide a transmitter that is easy to make more compact or simpler, to provide a receiver that is easy to make more compact or simpler, and to provide a communication system in which a transmitter and a receiver are easy to make more compact or simpler.

### BRIEF DESCRIPTION OF THE DRAWINGS

FIG. 1 is a block diagram illustrating a configuration of a communication system in accordance with one or more embodiments of the present invention.

FIG. 2 illustrates a plan view and a side view each of which illustrates a configuration of a transmitter illustrated in FIG. 1.

FIG. 3 is a block diagram illustrating Variation 1 of the transmitter illustrated in FIG. 1.

FIG. 4 is a block diagram illustrating Variation 2 of the transmitter illustrated in FIG. 1.

FIG. 5 is a block diagram illustrating Variation 3 of the transmitter illustrated in FIG. 1.

FIG. 6 is a block diagram illustrating Variation 4 of the transmitter illustrated in FIG. 1.

FIG. 7 illustrates a plan view and a side view each of which illustrates Variation 5 of the transmitter illustrated in FIG. 1.

### DETAILED DESCRIPTION

(Configuration of Communication System)

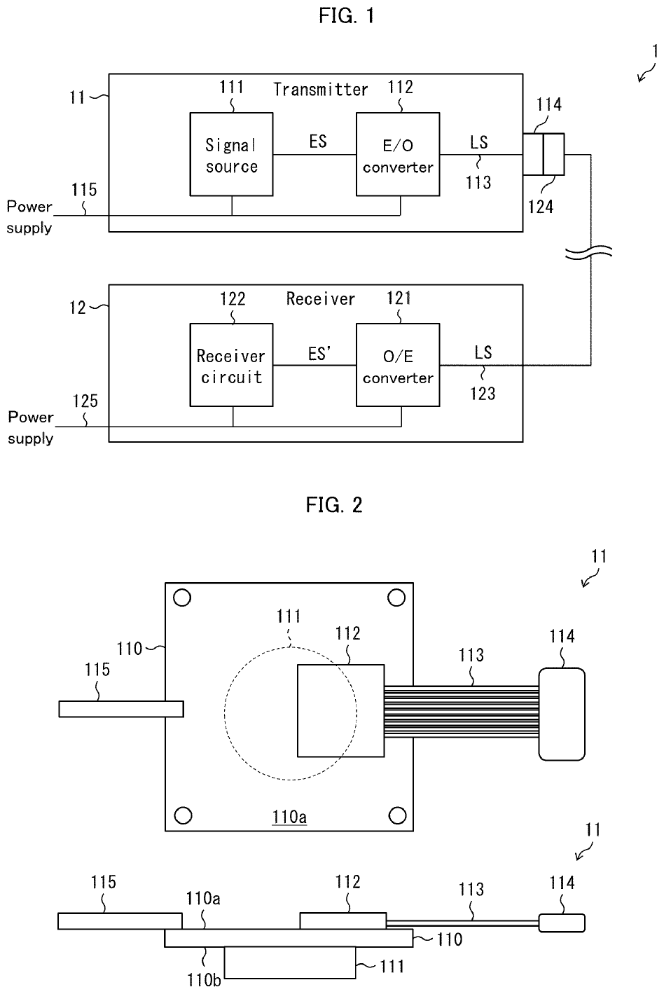

The following description will discuss a configuration of a communication system 1 in accordance with one or more embodiments of the present invention, with reference to FIG. 1. FIG. 1 is a block diagram illustrating a configuration of the communication system 1.

As illustrated in FIG. 1, the communication system 1 includes: a transmitter 11 that transmits an optical signal LS; and a receiver 12 that receives the optical signal LS.

The transmitter 11 includes: a signal source 111 that outputs an electrical signal ES; an E/O converter 112 that converts the electrical signal ES into an optical signal LS; an optical cable 113 that carries the optical signal LS outputted from the E/O converter 112. The receiver 12 includes an OLE converter 121 that converts the optical signal LS into an electrical signal ES′; a receiver circuit 122 that processes, as the electrical signal ES outputted from the signal source 111, the electrical signal ES' outputted from the O/E converter 121; and an optical cable 123 that carries the optical signal LS to be inputted to the OLE converter 121. This configuration makes it possible to provide the communication system 1, the transmitter 11, and the receiver 12 that are capable of transmitting, over a long distance and at a high rate, the electrical signal ES outputted from the signal source 111. In other words, this configuration makes it possible to yield an effect similar to that yielded by monitoring, in real time in a device that is apart from the signal source 111 and that is electrically connected to the receiver 12, the electrical signal ES outputted from the signal source 111. Further, the electrical signal ES outputted from the signal source 111 is inputted to the E/O converter 112 without the intervention of a general-purpose communications interface (such as a USB interface and an HDMI). This eliminates the provision of a general-purpose communications interface in the transmitter 11 and/or the receiver 12. It is therefore easy to make the transmitter 11 and/or the receiver 12 more compact or simpler.

In one or more embodiments, the signal source 111 is an image sensor and the electrical signal ES is an image signal outputted from the image sensor. In one or more embodiments, the receiver circuit 122 processes, as the image signal outputted from the image sensor, the electrical signal ES' outputted from the O/E converter 121. It is therefore possible to provide the communication system 1, the transmitter 11, and the receiver 12 that are capable of transmitting, over a long distance and at a high rate, the electrical signal outputted from the image sensor. In other words, it is possible to monitor, in real time at a location that is apart from the image sensor and that is near or in the receiver 12, the image signal outputted from the image sensor.

Examples of the image signal outputted from the image sensor include an image signal compliant with a scalable low voltage signaling embedded clock (SLVS-EC) or a mobile industry processor interface (MIPI) (registered trademark). It should be noted that the SLVS-EC and the MIPI are communications standards used exclusively for image transmission and are not general-purpose communications standards such as a USB and an HDMI. The image signal compliant with the SLVS-EC contains a clock in a data column thereof and is therefore advantageously free of skews (variations in delay time). Further, the image signal compliant with the SLVS-EC has a good DC balance and, therefore, may be used to establish optical communications between devices. The MIPI is a common standard. When the image signal is compliant with the MIPI, it is possible to connect the transmitter 11 to many kinds of devices compliant with the MIPI and to connect the many kinds of devices compliant with the MIPI to the receiver 12 (which will be described later). The image signal compliant with the MIPI, therefore, may be used for inter-device communications between the many kinds of devices.

In one or more embodiments, the transmitter 11 further includes an optical connector 114 provided at an end of the optical cable 113. The optical cable 113 can therefore be understood as an optical cable that connects the E/O converter 112 and the optical connector 114. The transmitter 11 may further include a housing for housing at least the signal source 111 and the E/O converter 112. The optical connector 114 may be provided at an end part of the housing of the transmitter 11, or may be provided to be apart from the end part of the housing of the transmitter 11. In one or more embodiments, the receiver 12 further includes an optical connector 124 provided at an end of the optical cable 123. The optical cable 123 can therefore be understood as an optical cable that connects the O/E converter 121 and the optical connector 124. The receiver 12 may further include a housing for housing at least the receiver circuit 122 and the O/E converter 121. The optical cable 123 is drawn from an end part of the housing of the receiver 12 and extends outside the receiver 12. The optical connector 124 may be provided at the end part of the housing of the receiver 12, or may be provided to be apart from the end part of the housing of the receiver 12. When the optical connectors 114 and 124 are connected to each other, the E/O converter 112 of the transmitter 11 is optically coupled to the O/E converter 121 of the receiver 12. The optical connector 114 and the optical connector 124 are removable connectors. This makes it possible to, when a failure occurs in the transmitter 11 (including the optical cable 113) of the communication system 1, replace the transmitter 11 without making a change to the receiver 12 (including the optical cable 123). Similarly, when a failure occurs in the receiver 12 (including the optical cable 123) of the communication system 1, it is possible to replace the receiver 12 without making a change to the transmitter 11 (including the optical cable 113). It is therefore easy, in the communication system 1, to address a failure that occurs in the transmitter 11 and/or the receiver 12. In the communication system 1, the optical cable 113 or the optical cable 123 is supposed to be used while being kept fixed. Examples of an aspect of the fixation of the optical cable 113 and the optical cable 123 include burying the optical cable 113 and the optical cable 123 in the ground. In the communication system, when a failure occurs in the transmitter 11 or the optical cable 113 while the optical cable 113 or the optical cable 123 are kept fixed, it is possible to replace the transmitter 11 without making a significant change to the receiver 12 or the optical cable 123. Further, the communication system 1, which includes the signal source 111 which is an image sensor, may be regarded as an aspect of an imaging system. Such an imaging system has performance that depends mainly on the signal source 111 included in the transmitter 11. When a user wishes to, for example, upgrade the signal source 111 in terms of resolution, or replace the signal source 111 with an infrared image sensor, it is possible, in the communication system 1, to upgrade or replace the transmitter 11 without making a significant change to the receiver 12 or the optical cable 123. Further, in a case where the signal source 111 is used as, for example, an image sensor of a monitoring camera, the receiver 12 is often disposed at a place that escapes observation (for example, an indoor location such as a monitoring room or a control room), whereas the transmitter 11 is often disposed at a place that comes under observation (an outdoor location in which there is the movement of people and vehicles). The transmitter 11 is therefore more likely to frequently break down than the receiver 12 is. For the above reasons, the communication system 1, in which it is possible to replace the transmitter 11 without making a significant change to the receiver 12 or the optical cable 123, is a rational communication system. Even when a failure occurs in the receiver 12 or the optical cable 123 while the optical cable 113 or the optical cable 123 is kept fixed, it is possible, in the communication system 1, to replace the receiver 12 without making a significant change to the transmitter 11 or the optical cable 113. In this context, when the transmitter 11 includes the above-described housing having an end part at which the optical connector 114 is provided, the optical cable 113 is housed in the optical connector 114 and the housing. This makes it possible to reduce or prevent failure occurrences in the optical cable 113 that are caused by external force or the like. Further, when the receiver 12 includes the above-described housing having an end part at which the optical connector 124 is provided, the optical cable 123 is housed in the optical connector 124 and the housing. This makes it possible to reduce or prevent failure occurrences in the optical cable 123 that are caused by external force or the like.

In an aspect of the communication system 1, the optical connector 114 and the optical connector 124 may be indirectly connected to each other by using an optical cable that is separate from the optical cable 113 and the optical cable 123. Alternatively, the optical connector 114 and the optical connector 124 may be directly connected to each other. Even when a failure occurs in the transmitter 11 and/or the receiver 12 while the optical cable connecting the optical connector 114 to the optical connector 124 is kept fixed, the former configuration in particular makes it possible to easily replace the faulty device.

General-purpose communications interfaces tend to generate heat while operating. The transmitter and/or the receiver that are/is provided with a general-purpose communications interface are/is therefore likely to become relatively large in size in consideration of the heat generated by the general-purpose communications interface. Accordingly, it is difficult to make the transmitter and/or the receiver compact. Conversely, the transmitter 11 and/or the receiver 12 do not need to be provided with a general-purpose communications interface, as described above. This eliminates the need to consider the heat generated by the general-purpose communications interface, and thereby makes it possible to make the transmitter 11 and/or the receiver 12 more compact.

In a case where the signal source 111 outputs n electrical signals as the electrical signal ES, the E/O converter 112 outputs n optical signals as the optical signal LS (n is any natural number that is not less than one). In this case, for example, an optical cable having n cores is used as the optical cables 113 and 123. Also in this case, a multi-fiber push on (MPO) connector having n or more cores is used as the optical connectors 114 and 124. The number of the cores of the MPO is not limited but may be selected as appropriate. The common number of the cores of the MPO includes 12 and 24.

In one or more embodiments, the transmitter 11 further includes a metal cable 115 that carries electric power to be supplied to at least the signal source 111 and which is independent of the optical cable 113. This enables, in the communication system 1, supply of electric power to the signal source 111 from a power supply disposed near or in the transmitter 11. This power supply is an example of a transmitting-side power supply and is for supplying electric power to the signal source 111. According to an aspect of the present invention, the metal cable 115 may be configured to supply electric power only to the signal source 111, may be configured to supply electric power to the signal source 111 and to the E/O converter 112, or may be configured to supply electric power only to the E/O converter 112. Accordingly, the metal cable 115 may be electrically connected only to the signal source 111, may be electrically connected to the signal source 111 and to the E/O converter 112, or may be electrically connected only to the E/O converter 112. In one or more embodiments, the electric power having been transmitted through the metal cable 115 is supplied to the E/O converter 112 as well as the signal source 111. This configuration eliminates the need to so provide a metal cable carrying electric power to the signal source 111 and the E/O converter 112 that the metal cable runs parallel to the optical cable 113. In other words, it is not necessary to use, as a cable to be connected to the E/O converter 112, a composite cable including an optical cable and a metal cable. The above configuration therefore makes it possible to make simpler the structure of the cable to be connected to the E/O converter 112 than a configuration in which a composite cable is used as the cable to be connected to the E/O converter 112. This enables a cost reduction. In addition, it can be possible to increase a transmission distance in the communication system 1. Furthermore, it can be possible to make the cable more compact and/or lighter. Provision of the cable in the form of an optical cable can enable a reduction in or prevention of a drop in voltage. Note that, in a case where the transmitter 11 includes a control section such as a microcomputer, electric power having been transmitted through the metal cable 115 may be supplied to this control section. Although the metal cable 115 and the E/O converter 112 are electrically connected to each other in the one or more embodiments, the metal cable 115 and the E/O converter 112 may not be electrically connected to each other.

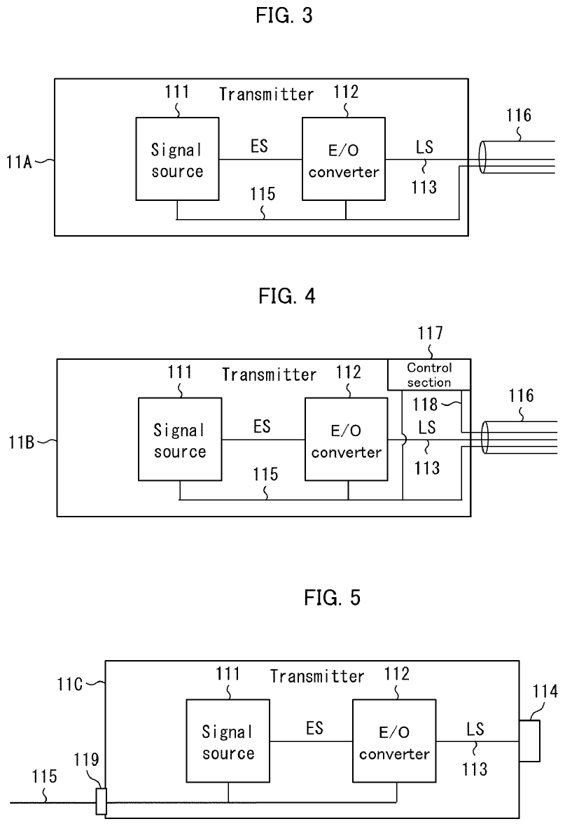

In one or more embodiments, the metal cable 115 has one end that is electrically connected to the signal source 111 and to the E/O converter 112. The metal cable 115 is an example of a metal cable for connecting a transmitting-side power supply, the metal cable being connectable to the transmitting-side power supply when the transmitting-side power supply is disposed outside the transmitter 11 and being capable of supplying electric power from the transmitting-side power supply to the signal source 111 and the E/O converter 112. The metal cable 115 is drawn from the housing of the transmitter 11 so as to be connectable to the transmitting-side power supply. This enables wiring of the metal cable 115 that is carried out independently of the optical cable 113 and the optical cable 123. It is therefore possible to determine a wiring route of the metal cable 115 independently of the wiring routes of the optical cable 113 and the optical cable 123. This eliminates the need to supply electric power from the receiver 12 to the signal source 111 and the E/O converter 112 of the transmitter 11, and therefore eliminates the need to use, as in Variation 1 (see FIG. 3), a composite cable 116 that includes the optical cable 113 and the metal cable 115. Accordingly, in a case where the transmitter 11 is connected to the receiver 12 by using a cable, one or more embodiments enable a reduction in the outer diameter of the cable in comparison with Variation 1.

In one or more embodiments, the receiver 12 includes a metal cable 125 that carries electric power to be supplied to the receiver circuit 122. This enables, in the communication system 1, supply of electric power from a power supply disposed near the receiver 12 to the receiver circuit 122. In one or more embodiments, the electric power having been transmitted through the metal cable 125 is supplied to the OLE converter 121 as well as the receiver circuit 122. In a case where the receiver 12 includes a control section such as a microcomputer, the electric power having been transmitted through the metal cable 125 may be supplied to this control section. Although the metal cable 125 and the OLE converter 121 is electrically connected to each other in one or more embodiments, the metal cable 125 and the OLE converter 121 may not be electrically connected to each other.

In one or more embodiments, the metal cable 125 has one end that is electrically connected to the OLE converter 121 and to the receiver circuit 122. The metal cable 125 is an example of a metal cable for connecting a receiving-side power supply, the metal cable being connectable to the receiving-side power supply when the receiving-side power supply is disposed outside the receiver 12 and being capable of supplying electric power from the receiving-side power supply to the OLE converter 121 and the receiver circuit 122. The metal cable 125 is drawn from the housing of the receiver 12 so as to be connectable to the receiving-side power supply. Accordingly, in a case where the transmitter 11 is connected to the receiver 12 by using a cable, one or more embodiments enable a reduction in the outer diameter of the cable, as is the case for the transmitter 11.

Since the transmitter 11 further includes the metal cable 115 as described above, it is possible to use soldering to electrically connect an end of the metal cable 115 to a substrate 110. In this case, it is possible to connect the metal cable 115 to the substrate 110 by using a simpler configuration than in a case of using a connector. This makes it possible to connect the metal cable 115 to the substrate 110 via solder. That is, it is possible to reduce manufacturing costs of the transmitter 11. The soldered connections have higher reliability than, for example, connections by using a connector. The receiver 12 further including the metal cable 125 also yields the same effect.

Although the signal source 111 is an image sensor in one or more embodiments, the present invention is not limited to this. The signal source 111 can be any device that outputs an electrical signal. Examples of a device that is usable as the signal source 111 include a sensor such as an image sensor, a color sensor, a luminance sensor, a wavelength sensor, a temperature sensor, a vibration sensor, or a strain sensor or a processor such as a central processing unit (CPU).

Although the electrical signal ES outputted from the signal source 111 is inputted as is into the E/O converter 112 in one or more embodiments, the present invention is not limited to this. The E/O converter 112 can receive an electrical signal that is obtained by processing, with the use of a signal processing circuit such as a serializer, the electrical signal ES outputted from the signal source 111 (see Variation 4 that will be described later).

In a case where the electrical signal ES outputted from the signal source 111 is inputted as is into the E/O converter 112, it is not necessary to provide the transmitter 11 with a signal processing circuit such as a serializer. This enables a simplification of the configuration of the transmitter 11. Further, it is not necessary, in this case, to provide the receiver 12 with a signal processing circuit such as a deserializer. This enables a simplification of the configuration of the receiver 12. For example, an image signal compliant with the SLVS-EC, which contains a clock in the data column thereof, may be applicable to this aspect. The advantages of the configuration in which a signal processing circuit such as a serializer is used will be described later in Variation 4 of the transmitter.

Although the metal cable 115 that carries electric power to be supplied to the signal source 111 is a metal cable independent of the optical cable 113 in one or more embodiments, the present invention is not limited to this. Specifically, the metal cable 115 that carries electric power to be supplied to the signal source 111 can be a metal cable that, together with the optical cable 113, constitutes a composite cable (see Variations 1 and 2 which will be described later). Alternatively, the transmitter 11 may include, instead of the metal cable 115, an electrical connector for connecting the metal cable 115 (see Variation 3 which will be described later).

(Configuration of Transmitter)

The following description will discuss a configuration of the transmitter 11 with reference to FIG. 2. FIG. 2 illustrates a plan view (the upper diagram) and a side view (the lower diagram) each of which illustrates a configuration of the transmitter 11.

The transmitter 11 includes a single substrate 110 in addition to the signal source 111, the E/O converter 112, the optical cable 113, the optical connector 114, and the metal cable 115 that are described earlier. Both the signal source 111 and the E/O converter 112 are provided to the substrate 110. This configuration makes it easier to make the transmitter 11 more compact than a configuration in which the signal source 111 or the E/O converter 112 alone is provided to the substrate 110.

In particular, the E/O converter 112 is provided to a main surface 110a, which is one main surface of the substrate 110, and the signal source 111 is provided to a main surface 110b, which is the other main surface of the substrate 110, in one or more embodiments. This makes it possible to dispose the signal source 111 and the E/O converter 112 in an overlapping manner, and thereby increases a density at which the substrate 110 is packed and reduces the area of the substrate 110. As a result, it is possible to more easily make the transmitter 11 more compact.

In one or more embodiments, a first footprint is larger than a second footprint. The first footprint is an area occupied by the signal source 111 on the main surface 110b of the substrate 110. The second footprint is an area occupied by the E/O converter 112 on the main surface 110a of the substrate 110. This makes it possible to both use a signal source capable of outputting massive data as the signal source 111 and improve flexibility in providing various parts (including the optical cable 113 and the metal cable 115) to the main surface 110a.

Although an end of the optical cable 113 is disposed on the main surface 110a (the same main surface that the E/O converter 112 is provided to)-side of the substrate 110 in one or more embodiments, the present invention is not limited to this. For example, in a case where the substrate 110 is a glass substrate, the end of the optical cable 113 may be disposed on the main surface 110b (the main surface opposite to that the E/O converter 112 is provided to) of the substrate 110. In this case, a configuration may be applied in which the optical signal LS outputted from the E/O converter 112 is passed through the substrate 110, then reflected by a turning mirror, and then inputted to the end of the optical cable 113. The turning mirror is disposed so that the optical signal LS outputted from the E/O converter 112 is reflected so as to be optically coupled to the end of the optical cable 113.

(Variation 1 of Transmitter)

The following description will discuss a transmitter 11A, which is Variation 1 of the transmitter 11, with reference to FIG. 3. FIG. 3 is a block diagram of the transmitter 11A in accordance with Variation 1.

In the transmitter 11 illustrated in FIG. 1, a metal cable independent of the optical cable 113 is used as the metal cable 115 that carries electric power to be supplied to the signal source 111. In contrast, in the transmitter 11A illustrated in FIG. 3, a metal cable that, together with the optical cable 113, constitutes a composite cable 116 is used as the metal cable 115 that carries electric power to be supplied to the signal source 111. The transmitter 11A illustrated in FIG. 3 therefore enables supply of electric power to the signal source 111 from a power supply which is apart from the signal source 111 and which is electrically connected to the receiver 12. Accordingly, it is possible to use a single composite cable 116 to achieve not only inter-device communications but also supply of electric power to the signal source 111 and/or the E/O converter 112. This enables a simplification of the configuration of the transmitter 11. Although the metal cable 115 is electrically connected to the E/O converter 112 in the present variation, the metal cable 115 may not be electrically connected to the E/O converter 112. However, the metal cable 115 may be electrically connected to the E/O converter 112. This configuration eliminates the need to so provide a metal cable carrying electric power to the signal source 111 and the E/O converter 112 that the metal cable runs parallel to the optical cable 113. That is, it is not necessary to use, as a cable to be connected to the E/O converter 112, a composite cable including an optical cable and a metal cable. The above configuration therefore makes it possible to make simpler the structure of the cable to be connected to the E/O converter 112 than a configuration in which a composite cable is used as the cable to be connected to the E/O converter 112. This can enable a cost reduction. In addition, it can be possible to increase a transmission distance in the communication system 1. It can also be possible to make the cable more compact and/or lighter. In a case where the cable is provided in the form of an optical cable, it can be possible to reduce or prevent a drop in voltage.

(Variation 2 of Transmitter)

The following description will discuss a transmitter 11B, which is Variation 2 of the transmitter 11, with reference to FIG. 4. FIG. 4 is a block diagram of the transmitter 11B in accordance with Variation 2.

In the transmitter 11 illustrated in FIG. 1, a metal cable independent of the optical cable 113 is used as the metal cable 115 that carries electric power to be supplied to the signal source 111. In contrast, in the transmitter 11B illustrated in FIG. 4, a metal cable that, together with the optical cable 113, constitutes the composite cable 116 is used as the metal cable 115 that carries electric power to be supplied to the signal source 111. Accordingly, using the transmitter 11B illustrated in FIG. 4 enables supply of electric power to the signal source 111 from a power supply which is apart from the signal source 111 and which is electrically connected to the receiver 12.

Further, the transmitter 11B illustrated in FIG. 4 includes a control section 117. In addition, in the transmitter 11B illustrated in FIG. 4, a metal cable that, together with the optical cable 113, constitutes the composite cable 116 and the metal cable 115 is used as a metal cable 118 that carries a control signal to be supplied to the control section 117. The transmitter 11B illustrated in FIG. 4 therefore enables supply of a control signal to the control section 117 from a control signal source disposed near or in the receiver 12. Although the metal cable 115 and the E/O converter 112 are electrically connected to each other in the present variation, the metal cable 115 and the E/O converter 112 may not be electrically connected to each other. However, the metal cable 115 and the E/O converter 112 may be electrically connected to each other. This configuration eliminates the need to so provide a metal cable carrying electric power to the signal source 111 and the E/O converter 112 that the metal cable runs parallel to the optical cable 113. That is, it is not necessary to use, as a cable to be connected to the E/O converter 112, a composite cable including an optical cable and a metal cable. The above configuration therefore makes it possible to make simpler the structure of the cable to be connected to the E/O converter 112 than a configuration in which a composite cable is used as the cable to be connected to the E/O converter 112. This can enable a cost reduction. In addition, it can be possible to increase a transmission distance in the communication system 1. It can also be possible to make the cable more compact and/or lighter. In a case where the cable is provided in the form of an optical cable, it can be possible to reduce or prevent a drop in voltage.

(Variation 3 of Transmitter)

The following description will discuss a transmitter 11C, which is Variation 3 of the transmitter 11, with reference to FIG. 5. FIG. 5 is a block diagram of the transmitter 11C in accordance with Variation 3.

In the transmitter 11 illustrated in FIG. 1, provided is a metal cable 115 that carries electric power to be supplied to the signal source 111. In contrast, in the transmitter 11C illustrated in FIG. 5, provided is an electrical connector 119 for connecting the metal cable 115 that carries electric power to be supplied to the signal source 111. The transmitter 11C illustrated in FIG. 5 therefore enables easy attachment and detachment of the metal cable 115 that carries electric power to be supplied to the signal source 111. In the present variation, the metal cable 115 may be electrically connected only to the signal source 111, may be electrically connected to the signal source 111 and to the E/O converter 112, or may be electrically connected only to the E/O converter 112. However, the metal cable 115 may be electrically connected to the signal source 111 and to the E/O converter 112. This configuration eliminates the need to provide, via the optical connector 114, another cable for supplying electric power to the signal source 111 or the E/O converter 112, in addition to the metal cable 115. This makes it possible to transmit electric power to the signal source 111 and the E/O converter 112 by using a single cable. The above configuration therefore makes it possible to make simpler the structure of the cable provided via the optical connector 114 than a configuration in which the metal cable 115 is electrically connected only to the signal source 111 or only to the E/O converter 112. This can enable a cost reduction. In addition, it can be possible to increase a transmission distance in the communication system 1. It can also be possible to make the cable more compact and/or lighter. In a case where the cable is provided as an optical cable, it can be possible to reduce or prevent a drop in voltage.

(Variation 4 of Transmitter)

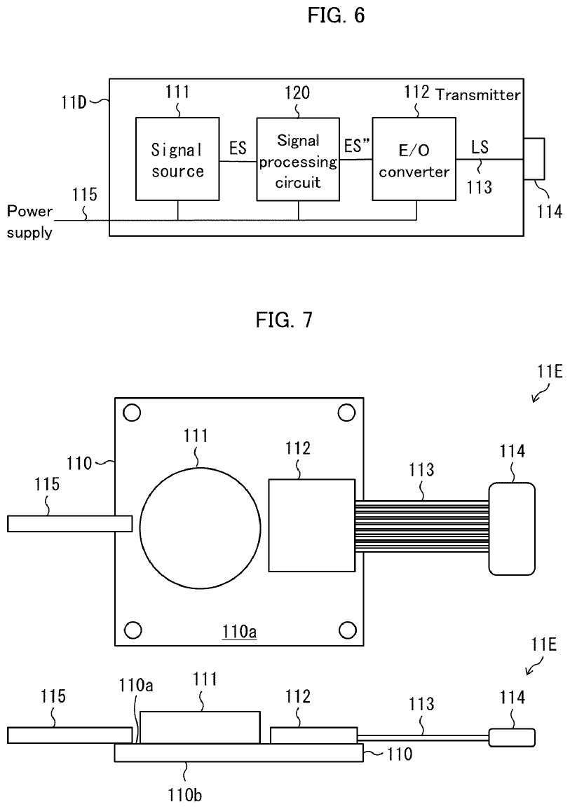

The following description will discuss a transmitter 11D, which is Variation 4 of the transmitter 11, with reference to FIG. 6. FIG. 6 is a block diagram of the transmitter 11D in accordance with Variation 4.

In the transmitter 11 illustrated in FIG. 1, the electrical signal ES outputted from the signal source 111 is inputted as is into the E/O converter 112. In contrast, in the transmitter 11D illustrated in FIG. 6, the E/O converter 112 receives an electrical signal ES″ that is obtained by processing, with the use of a signal processing circuit 120, the electrical signal ES outputted from the signal source 111. For example, in a case where the signal source 111 is an image sensor, a serializer is used as the signal processing circuit 120 to serialize image signals outputted as the electrical signal ES in parallel from the signal source 111 and a clock signal. This makes it possible to transmit the image signals outputted as the electrical signal ES in parallel from the signal source 111 and the clock signal, over a long distance and at a high rate without generating a skew (a variation in delay time). In addition, the above serialization enables a reduction in the number of cores that constitutes the optical cable 113. The above serialization also makes it possible to reduce the number of the E/O converters 112 to, for example, one. In the present variation, the metal cable 115 may be electrically connected only to the signal source 111, may be electrically connected to the signal source 111 and to the signal processing circuit 120, may be electrically connected to the signal source 111 and to the E/O converter 112, or may be electrically connected to the signal source 111, to the signal processing circuit 120, and to the E/O converter 112. However, the metal cable 115 may be electrically connected to the signal source 111, to the E/O converter 112, and to the signal processing circuit 120. This configuration eliminates the need to provide, via the optical connector 114, another cable for supplying electric power to at least any one of the signal source 111, the E/O converter 112, and the signal processing circuit 120, in addition to the metal cable 115. Accordingly, it is possible to transmit, by using a single cable, electric power to the signal source 111, the E/O converter 112, and the signal processing circuit 120. The above configuration therefore makes it possible to make simpler the structure of the cable that is provided via the optical connector 114 than a configuration in which the metal cable 115 and the signal source 111, the E/O converter 112, and the signal processing circuit 120 are not electrically connected to each other. This enables a cost reduction. In addition, it can be possible to increase a transmission distance in the communication system 1. It can also be possible to make the cable more compact and/or lighter. In a case where the cable is provided in the form of an optical cable, it can be possible to reduce or prevent a drop in voltage.

(Variation 5 of Transmitter)

The following description will discuss a transmitter 11E, which is Variation 5 of the transmitter 11, with reference to FIG. 7. FIG. 7 illustrates a plan view (the upper diagram) and a side view (the lower diagram) each of which illustrates a configuration of the transmitter 11E in accordance with Variation 5.

In the transmitter 11 illustrated in FIG. 2, the E/O converter 112 is provided to the main surface 110a, which is one main surface of the substrate 110, and the signal source 111 is provided to the main surface 110b, which is the other main surface of the substrate 110. In contrast, in the transmitter 11E illustrated in FIG. 7, both the signal source 111 and the E/O converter 112 are provided to the main surface 110a, which is the one main surface of the substrate 110. This configuration makes it possible to dispose the signal source 111 and the E/O converter 112 side by side, and thereby makes it possible to keep the substrate 110 thin. This makes it easier to make the transmitter 11E more compact in thickness.

[Main Points]

A transmitter in accordance with Aspect 1 of the present invention includes a configuration in which the transmitter includes a substrate; a signal source provided to the substrate; an E/O converter provided to the substrate and configured to convert, into an optical signal, an electrical signal outputted from the signal source; an optical cable that carries the optical signal outputted from the E/O converter; and an optical connector provided at an end of the optical cable, the electrical signal outputted from the signal source being inputted as is into the E/O converter.

A transmitter in accordance with Aspect 2 of the present invention includes, in addition to the configuration of the transmitter in accordance with Aspect 1, a configuration in which the transmitter further including a housing that houses at least the signal source and the E/O converter, wherein the optical connector is provided at an end part of the housing.

A transmitter in accordance with Aspect 3 of the present invention includes, in addition to the configuration of the transmitter in accordance with Aspect 1 or 2, a configuration in which the transmitter further includes a metal cable independent of the optical cable, wherein the metal cable is for connecting a transmitting-side power supply, the metal cable being connectable to the transmitting-side power supply when the transmitting-side power supply is disposed outside the transmitter and being capable of supplying electric power from the transmitting-side power supply to the signal source and the E/O converter.

A transmitter in accordance with Aspect 4 of the present invention includes, in addition to the configuration of the transmitter in accordance with Aspect 1 or 2, a configuration in which the transmitter further includes a metal cable that, together with the optical cable, constitutes a composite cable, wherein the metal cable is capable of supplying electric power to the signal source.

A transmitter in accordance with Aspect 5 of the present invention includes, in addition to the configuration of the transmitter in accordance with any one of Aspects 1 to 4, a configuration in which the transmitter further includes an electrical connector for connecting a metal cable that carries electric power to be supplied to the signal source.

A transmitter in accordance with Aspect 6 of the present invention includes, in addition to the configuration of the transmitter in accordance with any one of Aspects 1 to 5, a configuration in which the E/O converter is provided to one main surface of the substrate; the signal source is provided to the other main surface of the substrate; a first footprint that is an area occupied by the signal source on the other main surface of the substrate is larger than a second footprint that is an area occupied by the E/O converter on the one main surface of the substrate.

A transmitter in accordance with Aspect 7 of the present invention includes, in addition to the configuration of the transmitter in accordance with any one of Aspects 1 to 6, a configuration in which the signal source and the E/O converter are provided to one main surface of the substrate.

A receiver in accordance with Aspect 8 of the present invention includes a configuration in which the receiver includes an OLE converter configured to convert an optical signal into an electrical signal; and a receiver circuit configured to process, as an electrical signal outputted from a signal source, the electrical signal outputted from the OLE converter. The receiver in accordance with Aspect 8 of the present invention may include, in addition to the configuration of the receiver in accordance with Aspect 8, a configuration in which the optical signal is an optical signal transmitted from a transmitter in accordance with any one of Aspects 1 to 6.

A communication system in accordance with Aspect 9 of the present invention includes a configuration in which the communication system includes: a transmitter in accordance with any one of Aspects 1 to 7; and a receiver in accordance with Aspect 8.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: Communication system
11: Transmitter
110: Substrate
111: Signal source
112: E/O converter
113: Optical cable
114: Optical connector
115: Metal cable (for electric power transmission)
116: Composite cable
117: Control section
118: Metal cable (for control signal transmission)
119: Electrical connector
120: Signal processing circuit
12: Receiver
121: O/E converter
122: Receiver circuit
123: Optical cable
124: Optical connector
125: Metal cable (for electric power transmission)

1. A transmitter comprising:
a substrate;
a signal source disposed on the substrate;
an electrical-to-optical (E/O) converter disposed on the substrate and that converts an electrical signal outputted from the signal source into an optical signal;
an optical cable that carries the optical signal; and
an optical connector disposed at an end of the optical cable, wherein
the electrical signal is inputted into the E/O converter.

2. The transmitter according to claim 1, further comprising:
a housing that houses the signal source and the E/O converter, wherein
the optical connector is disposed at an end part of the housing.

3. The transmitter according to claim 1, further comprising:
a metal cable independent of the optical cable, wherein
the metal cable is:
for connecting a transmitting-side power supply,
connectable to the transmitting-side power supply when the transmitting-side power supply is disposed outside the transmitter, and
capable of supplying electric power from the transmitting-side power supply to the signal source and the E/O converter.

4. The transmitter according to claim 1, further comprising:
a metal cable, wherein
the metal cable and the optical cable constitute a composite cable,
the metal cable is capable of supplying electric power to the signal source.

5. The transmitter according to claim 1, further comprising an electrical connector for connecting a metal cable that carries electric power to be supplied to the signal source.

6. The transmitter according to claim 1, wherein
the E/O converter is disposed on a first main surface of the substrate,
the signal source is disposed on a second main surface of the substrate that is opposite to the first main surface,
a first footprint that is an area occupied by the signal source on the second main surface is larger than a second footprint that is an area occupied by the E/O converter on the first main surface.

7. The transmitter according to claim 1, wherein the signal source and the E/O converter are disposed on one main surface of the substrate.

8. A receiver comprising:
an optical-to-electrical (O/E) converter that converts an optical signal into an electrical signal; and
a receiver circuit that processes, as an electrical signal outputted from a signal source, the electrical signal outputted from the O/E converter.

9. A communication system comprising:
a transmitter according to claim 1; and
a receiver comprising:
an optical-to-electrical (O/E) converter that converts an optical signal into an electrical signal; and
a receiver circuit that processes, as an electrical signal outputted from a signal source, the electrical signal outputted from the O/E converter.
